(19) United States
(12) Patent Application Publication
(10) Pub. No.: US 2018/0311090 A1
(43) Pub. Date: Nov. 1, 2018

(54) PRESSURE-ELIMINATING SEATING APPARATUS

(71) Applicants: George Gregory STEPHENS, Trussville, AL (US); Lynn Babb STEPHENS, Trussville, AL (US)

(72) Inventors: George Gregory STEPHENS, Trussville, AL (US); Lynn Babb STEPHENS, Trussville, AL (US)

(21) Appl. No.: 15/883,644

(22) Filed: Jan. 30, 2018

Related U.S. Application Data
(60) Provisional application No. 62/490,397, filed on Apr. 26, 2017.

(51) Int. Cl. A61G 5/10

(52) U.S. Cl. CPC A61G 5/1045; A61G 5/124; A61G 5/1091

(57) ABSTRACT

According to at least one embodiment, a pressure-eliminating seating apparatus for preventing formation and/or treating existing pressure ulcers, sores, or lesions, and/or relieving nerve pain in a lower region of an immobilized person, or any other user, is disclosed. The seating apparatus may include a body having a front edge, a pair of opposed side edges, a rear edge, a depth, and an aperture defined therein. To allow for the immobilized person, or other user, to sit comfortably and properly on top of the seating apparatus, the seating apparatus may be compressed to a depth of approximately 4 inches. The seating apparatus may also include a cover to prevent the depth from expanding to greater than approximately 4 inches. The apparatus may allow for suspension of bony prominences in the lower region of the immobilized person, or other user, in air.

### CROSS-REFERENCE TO RELATED APPLICATIONS

This application claims priority from U.S. Provisional Patent Application No. 62/490,397, filed on Apr. 26, 2017, entitled “Zero Pressure Cushion,” the entire contents of which are hereby incorporated by reference.

### FIELD OF THE INVENTION

The present invention generally relates to a seating apparatus of the type that is appropriate for wheelchairs or other sitting devices, and more particularly, a pressure-eliminating seat cushion which prevents and/or treats pressure ulcers affecting immobilized individuals and/or relieves pain due to nerve compression in lower body regions of other users.

### BACKGROUND

Wheelchairs have been used in the health care industry for over two hundred years, assisting immobilized individuals regain some form of mobility. Wheelchair users, however, are often vulnerable to the occurrence of pressure ulcers after prolonged use of the chair. Constant pressure on one point of a bone can lead to the loss of circulation and the formation of sores, lesions and the like. Ideally, the weight of the immobilized person should be spread evenly along a seat cushion of the wheelchair, to avoid the formation of pressure points.

According to the National Pressure Ulcer Advisory Panel (NPUAP), a pressure ulcer is defined as localized injury to the skin and/or underlying tissue, usually over a bony prominence, as a result of pressure or pressure in combination with shear. In turn, if there is no pressure, there is no pressure ulcer. In wheelchair users, the ischium, coccyx, and sacrum are the three bony prominences in the lower body region most prone to the formation of pressure ulcers. It has been estimated that pressure ulcers can account for approximately one-fourth of the cost of care for individuals plagued with spinal cord injury (SCI), for example. In the U.S. alone, it has been estimated that the cost of care for pressure ulcers among the SCI population is about $1.2-1.3 billion annually. This amount increases significantly when all wheelchair users are included in the costs for treatment. Beyond financial implications, pressure ulcers are a source of significant morbidity and mortality. Each year, approximately 60,000 patients die as a direct result of pressure ulcers. Accordingly, careful attention has been directed in the medical industry to the development of seat cushions for wheelchairs which help reduce pressure over the bony prominences in the lower body region of the immobilized individual.

The prior art, in general, has attempted to reduce the frequency of developing pressure ulcers by minimizing the seating pressure under the immobilized individual. Various prior art seat cushions redistribute a portion of the force and pressure to areas less vulnerable to the occurrence of pressure ulcers. As an example, U.S. Pat. No. 5,487,197 discloses a prior art seat cushion which utilizes inflatable compartments filled with air or a gel, in which the pressure is alternately raised or lowered in different compartments so that an area of maximum pressure is not always in the same location. However, such prior art inflatable cushions cannot ensure that the seating pressure is adequately reduced because areas vulnerable to pressure ulcers always experience some level of pressure underneath both inflated and uninflated compartments.

The prior art has also attempted to reduce the frequency of developing pressure ulcers through the use of support structures with a plurality of movable elements. For example, U.S. Pat. Nos. 5,626,555 and 5,109,558 disclose support structures including a plurality of movable elements for supporting the immobilized person. The patent teaches that periodic relief of pressure through movement of the individual elements of the support structure can improve blood circulation and avoid sores or pressure ulcers.

Despite the widespread use of alternative types of wheelchair seat cushions, annual pressure ulcer incidence rates for SCI patients, for example, still range from 20-31%. The effectiveness of these other alternative seat cushions, in terms of preventing pressure ulcers, is limited because these alternatives merely reduce the pressure over the bony prominences in the lower body region of the immobilized person, not completely eliminate the pressure. There is therefore a need in the art for a seating apparatus of the type that is appropriate for wheelchairs or other sitting devices, which eliminates pressure on the bony prominences most prone to the formation of pressure ulcers in the lower body region of the immobilized individual.

### SUMMARY

According to at least one embodiment, a pressure-eliminating seating apparatus for supporting a lower region of an immobilized person is disclosed. The seating apparatus may prevent formation and/or treat existing pressure ulcers, sores, or lesions in the lower region of the immobilized person. Additionally, the seating apparatus may relieve pain due to nerve compression, for example, in the buttock and sacrum regions of other users. The seating apparatus may include a body having a shape with a front edge, a pair of opposed side edges, a rear edge, a depth, and an aperture defined therein. The aperture in the body may be defined substantially near a midpoint of a transverse axis of the seating apparatus. The body may be placed on a top surface of a seat support of a chair. The seating apparatus may further include a cover that substantially covers the body. The cover may restrict a depth of the body from expanding to a depth greater than approximately 4 inches.

According to another embodiment, a wheelchair is disclosed. The wheelchair may include a pair of front wheels, a pair of rear wheels, a frame having a front portion, a center portion, and a rear portion, the frame connecting the pair of front and rear wheels, a backrest connected to the rear portion of the frame, a seat support connected to the center portion of the frame, a pair of handles connected to the rear portion of the frame, a pair of side arm rests connected to the center portion of the frame, a pair of foot rests connected to the front portion of the frame, and a means for eliminating pressure on a lower body region of an immobilized person seated in the wheelchair. The means for eliminating pressure on the lower body region of the immobilized person may further include means for substantially suspending bony prominences in the lower body region of the immobilized person in air. The means for eliminating pressure on the lower body region of the immobilized person may also include eliminating pressure on the ischium, coccyx and sacrum regions of the immobilized person.

According to another embodiment, a method for eliminating pressure on a lower region of an immobilized person is disclosed. The method may include providing a seating apparatus configured to support the lower region of the immobilized person, the seating apparatus including a body having a shape with a front edge, a pair of opposed side edges, a rear edge, a depth, and an aperture defined therein. The method may further include the steps of placing the seating apparatus on a top surface of a seat support of a chair, sitting the immobilized person on the seating apparatus, and substantially suspending bony prominences in the lower region of the immobilized person in air.

According to another embodiment, a method for preventing formation and/or treating pressure ulcers, sores, or lesions, and/or relieving nerve pain in a lower body region of an immobilized person, or any other user, is disclosed. The method may include providing a chair having a pressure-eliminating seating apparatus for supporting the lower body region of the immobilized person, or other user, and sitting the immobilized person, or other user, on the pressure-eliminating seating apparatus.

### BRIEF DESCRIPTION OF THE DRAWINGS

FIG. 1 is a side view of an immobilized individual supported on a pressure-eliminating seating apparatus in a wheelchair;

FIG. 2 is a perspective view of an exemplary embodiment of the pressure-eliminating seating apparatus; and

FIG. 3 is a perspective view of an exemplary embodiment of a cushion cover substantially covering the pressure-eliminating seating apparatus.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description, discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments”, or “invention” do not require that all embodiments of the invention include the discussed feature, advantage, or mode of operation.

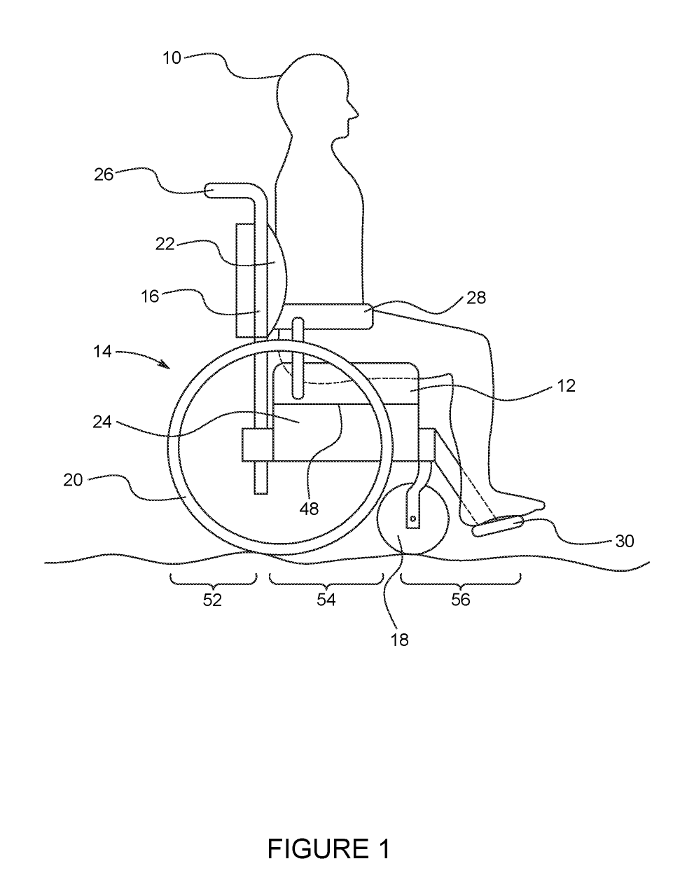

Referring to FIG. 1, according to an exemplary embodiment, an immobilized individual or person 10 supported on a pressure-eliminating seating apparatus or seat cushion 12 in a wheelchair 14 can be seen. The wheelchair 14 may include a frame 16 having a rear portion 52, a center portion 54, and a front portion 56, onto which are mounted at least two swiveling front wheels 18 and at least two larger rear wheels 20. A backrest 22 is connected to the rear portion 52 of the frame 16, and a seat support 24 is connected to the center portion 54 of the frame 16, the backrest 22 and the seat support 24 forming the balance of the chair 14. The wheelchair 14 may further include handles 26 connected to the rear portion 52 of the frame 16 to assist in pushing the wheelchair 14, side arm rests 28 connected to the center portion 54 of the frame 16 for supporting the arms of the immobilized person 10, and foot rests 30 connected to the front portion 56 of the frame 16 for supporting the feet of the immobilized individual 10.

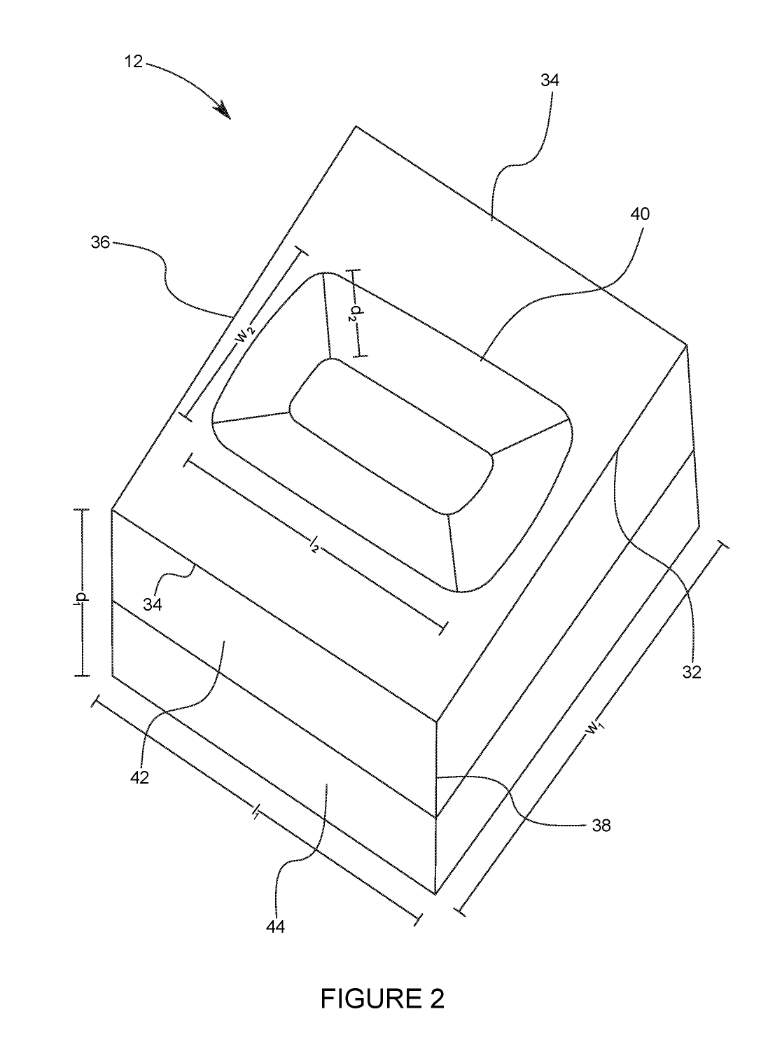

An exemplary embodiment of the pressure-eliminating seating apparatus or seat cushion 12 is depicted in FIG. 2. The seat cushion 12 generally includes a front edge 32, a pair of opposed side edges 34, a rear edge 36, and a thickness 38. Referring back to FIG. 1, the seat cushion 12 may be sized and shaped to be placed on a top surface 48 of the seat support 24 of the wheelchair 14. In an exemplary embodiment, the seat cushion 12 is substantially rectangular in shape. The pressure-eliminating seating apparatus 12 may further include an aperture 40 defined substantially near a midpoint of a transverse axis of the seat cushion 12, wherein a longitudinal axis of aperture 40 may be substantially parallel to a longitudinal axis of seat cushion 12. In one embodiment, in a pre-compressed state, the seat cushion 12 may have a width (w₁) ranging from about 14 inches to 24 inches, a length (l₁) ranging from about 14 inches to 22 inches, and a depth (d₁) ranging from about 6 inches to 8 inches.

As described above, the seat cushion 12 may include aperture 40 substantially near a center of the seat cushion 12. In one embodiment, the aperture 40 may have a width (w₂) ranging from about 5 inches to 6 inches, a length (12) ranging from about 10 inches to 11 inches, and a depth (d₂) ranging from about 6 inches to 8 inches. When the immobilized person 10 is seated on top of the seat cushion 12 in the wheelchair 14, the aperture 40 may have dimensions that facilitate substantially suspending the three bony prominences in the lower body region of the immobilized person 10 in the air. By eliminating contact of the ischium, coccyx, and sacrum regions, for example, with any surface of the seat cushion 12, constant pressure, or any type of pressure, may be eliminated on any one point of any of the bones, preventing the formation of pressure ulcers, sores, lesions and the like on these anatomical sites. According to another exemplary embodiment, by eliminating pressure on the ischium, coccyx, and sacrum regions, pain that may be experienced by the immobilized person 10, or any other user, due to compression of nerves in the buttock and sacrum regions may also be relieved. In another exemplary embodiment, the seat cushion 12 may be used to effectively treat existing pressure ulcers by eliminating pressure from being exerted on the affected anatomical sites such that the pressure ulcers have time to heal.

According to an exemplary embodiment, the seat cushion 12 may be constructed of a material that is both comfortable for the user and is non-collapsible in a vicinity of the aperture, thereby comfortably suspending the immobilized person's, or other user's, ischium, coccyx, and sacrum regions in the air. As a result, pressure is eliminated, and pressure ulcers are prevented from forming on these anatomical sites. At the same time, extended comfort is also provided to the immobilized person 10 who may be using the wheelchair 14 for a prolonged period of time. Referring to FIG. 2, in an exemplary embodiment, the seat cushion 12 may include a top layer 42 that may be constructed from a visco-elastic foam with an indentation load deflection (ILD) ranging from about 16 to 18 ILD and a bottom layer 44 that may be constructed from a standard foam with an ILD ranging from about 40 to 50 ILD. In another embodiment, the seat cushion may include three layers (not shown), with a top layer that may be constructed from a visco-elastic foam with about a 11 to 13 ILD, a middle layer that may be a visco-elastic foam with about a 20 ILD, and a bottom layer that may be constructed from a standard foam with about a 44 ILD. In another embodiment, the seat cushion 12 may be constructed of any material known to one having ordinary skill in the art that provides the comfort and non-collapsible features described above. As further illustrated in FIG. 2, the aperture 40, defined substantially near the center of the seat cushion 12, may extend through both the top layer 42 and the bottom layer 44 of the seat cushion 12.

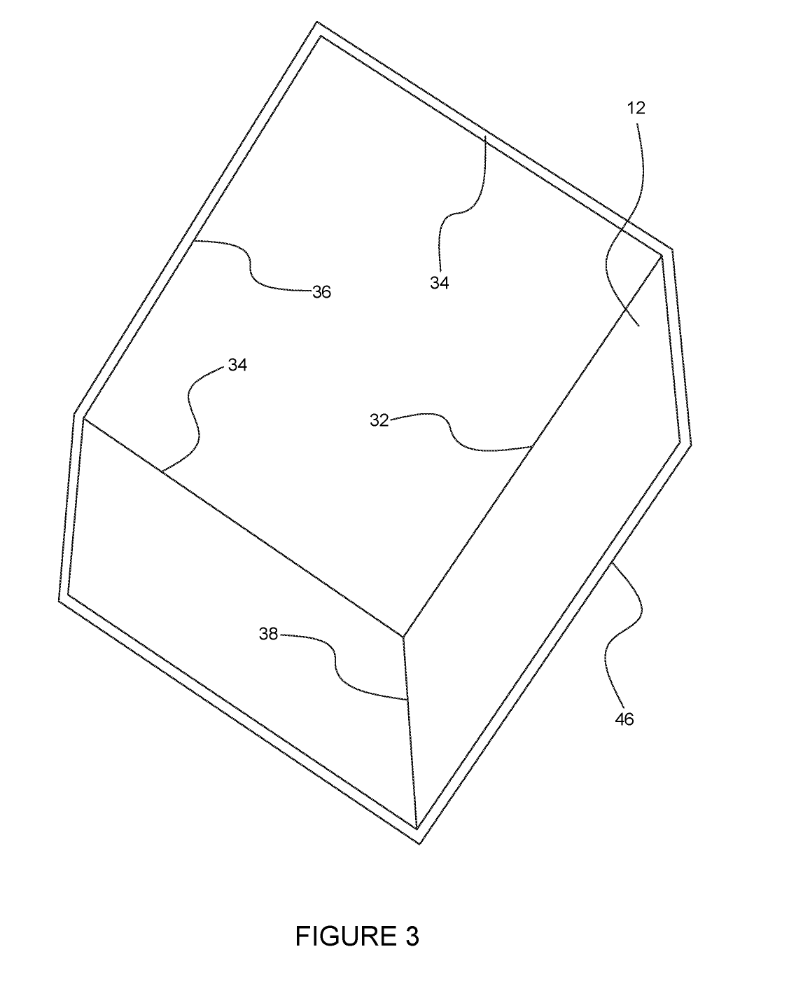

According to an exemplary embodiment, as depicted in FIG. 3, the seat cushion 12 may include a cushion cover 46, having substantially a same shape as the seat cushion 12. As discussed above, in the pre-compressed state, the seat cushion 12 may have a depth (d₁) ranging from about 6 inches to 8 inches. In order to allow the immobilized person 10, or any other user, to comfortably and properly sit on top of the seat cushion 12, the seat cushion 12 may be compressed to a depth of approximately 4 inches. The cushion cover 46 may be used to prevent the depth of the seat cushion 12 from expanding to a depth greater than approximately 4 inches. The cushion cover 46 may be constructed of any comfortable material known to one having ordinary skill in the art that possesses adequate structural strength to maintain a compressed depth of approximately 4 inches. For example, the cushion cover may be constructed of a polyester fabric. In one exemplary embodiment, the cushion cover 46 may be sized to fit inside aperture 40 (not shown in FIG. 3), while substantially covering the remainder of the seat cushion 12, including the front edge 32, the pair of opposed side edges 34, the rear edge 36, and the thickness 38. Alternatively, the cushion cover 46 may cover the aperture 40 as long as the cushion cover 46 is constructed of a material that has low resistance, substantially allowing the immobilized person's ischium, coccyx, and sacrum regions to be suspended within the aperture 40 in air.

To allow for multi-person use of the same wheelchair 14 at medical facilitates, for example, the cushion cover 46 may be removable and washable, providing a sanitary surface for the next immobilized person 10 using the wheelchair 14. According to an exemplary embodiment, a nurse at the hospital may first remove the seat cushion 12 on the top surface 48 of the seat support 24 of the wheelchair 14, replace the cushion cover 26 surrounding the seat cushion 12 with a new cushion cover 26, place the removed seat cushion 12 back on the top surface 48 of the seat support 24, and then assist the next immobilized person 10 to sit on top of the seat cushion 12 in the wheelchair 14.

As a method for preventing the formation of pressure ulcers, treating existing pressure ulcers, and/or relieving pain caused by nerve compression in the buttock and sacrum regions of an immobilized person 10, a medical facility, such as a hospital, may routinely provide the pressure-eliminating seating apparatus or seat cushion 12 on the top surface 48 of the seat support 24 of the wheelchair 14. The immobilized person 10 may then be seated on top of the seat cushion 12 such that the person's bony prominences in the lower body region most prone to the formation of pressure ulcers are substantially suspended in air over a center of aperture 40 of the seat cushion 12. By eliminating contact of the ischium, coccyx, and sacrum regions with any surface of the seat cushion 12, constant pressure, or any type of pressure, may be eliminated on any one point of any of the bones. The pressure-eliminating seating apparatus 12 thus prevents the formation of pressure ulcers, sores, lesions and the like on these anatomical sites while the immobilized person 10 is sitting on the wheelchair 14. Likewise, the pressure-eliminating seating apparatus 12 may treat existing pressure ulcers and/or relieve nerve pain in the immobilized person's 10 buttock and sacrum regions.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A pressure-eliminating seating apparatus for supporting a lower region of a person, comprising:
a body having a shape comprising a front edge, a pair of opposed side edges, a rear edge, a depth, and an aperture defined therein; and
a cover configured to substantially cover the body, the cover having substantially a same shape as the body,
wherein the body is configured to be placed on a top surface of a seat support of a chair,
wherein the aperture is defined substantially near a midpoint of a transverse axis of the body,
wherein the body is compressed to a depth of approximately 4 inches, and
wherein the cover supports the compressed depth of the body.

2. The pressure-eliminating seating apparatus of claim 1, wherein the body has a width of about 14 inches to 24 inches, a length of about 14 inches to 22 inches, and a depth of about 6 inches to 8 inches in a pre-compressed state.

3. The pressure-eliminating seating apparatus of claim 1, wherein the shape of the body is substantially rectangular, and
wherein the aperture has a width of about 5 inches to 6 inches, a length of about 10 inches to 11 inches, and a depth of about 6 inches to 8 inches in a pre-compressed state.

4. The pressure-eliminating seating apparatus of claim 1, wherein a longitudinal axis of the aperture is substantially parallel to a longitudinal axis of the body.

5. The pressure-eliminating seating apparatus of claim 1, wherein the body is formed of at least a first layer and a second layer, and
wherein the first layer is a visco-elastic foam layer and the second layer is a base foam layer.

6. The pressure-eliminating seating apparatus of claim 5, wherein the aperture is configured to extend through the first layer and the second layer.

7. A wheelchair, comprising:
a pair of front wheels;
a pair of rear wheels;
a frame having a front portion, a center portion, and a rear portion, the frame connecting the pair of front and rear wheels;
a backrest connected to the rear portion of the frame;
a seat support connected to the center portion of the frame;
a pair of handles connected to the rear portion of the frame;
a pair of side arm rests connected to the center portion of the frame;
a pair of foot rests connected to the front portion of the frame; and
a means for eliminating pressure on a lower body region of a person seated in the wheelchair.

8. The wheelchair of claim 7, wherein the means for eliminating pressure on the lower body region of the person further includes eliminating pressure on an ischium region, a coccyx region and/or a sacrum region of the person.

9. The wheelchair of claim 7, wherein the means for eliminating pressure on the lower body region of the person further includes means for substantially suspending bony prominences in the lower body region of the person in air.

10. The wheelchair of claim 9, wherein the bony prominences are in an ischium region, a coccyx region, and a sacrum region of the person.

11. A method for eliminating pressure on a lower region of a person, the method comprising the steps of:
providing a seating apparatus configured to support the lower region of the person, the seating apparatus comprising:
a body having a shape comprising a front edge, a pair of opposed side edges, a rear edge, a depth, and an aperture defined substantially near a midpoint of a transverse axis of the body; and
a cover configured to substantially cover the body, the cover having substantially a same shape as the body,
wherein the body is compressed to a depth of approximately 4 inches, and
wherein the cover supports the compressed depth of the body;
placing the seating apparatus on a top surface of a seat support of a chair;
sitting the person on the seating apparatus; and
substantially suspending bony prominences in the lower region of the person in air.

12. The method of claim 11, wherein the bony prominences are in an ischium region, a coccyx region, and a sacrum region of the person.

13. A method for preventing formation of pressure ulcers, sores, or lesions in a lower region of a person, the method comprising the steps of:
providing a chair having the pressure-eliminating seating apparatus for supporting the lower region of the person of claim 1; and
sitting the person on the pressure-eliminating seating apparatus.

14. A method for relieving nerve pain in a lower region of a person, the method comprising the steps of:
providing a chair having the pressure-eliminating seating apparatus of claim 1; and
sitting the person on the pressure-eliminating seating apparatus.

15. A method for treating pressure ulcers, sores, or lesions in a lower region of a person, the method comprising the steps of:
providing a chair having the pressure-eliminating seating apparatus for supporting the lower region of the person of claim 1; and
sitting the person on the pressure-eliminating seating apparatus.

16. The pressure-eliminating seating apparatus of claim 5, wherein the visco-elastic foam layer has an indentation load deflection ranging from about 16 to 18, and
wherein the base foam layer has an indentation load deflection ranging from about 40 to 50.

17. The pressure-eliminating seating apparatus of claim 1, wherein the cover is constructed of a polyester fabric.

18. The pressure-eliminating seating apparatus of claim 1, wherein the person is an immobilized person.
